(19) United States
(12) Patent Application Publication
(10) Pub. No.: US 2007/0260006 A1
(43) Pub. Date: Nov. 8, 2007

(54) Rigid polyvinyl chloride polymer compositions having improved impact properties

(76) Inventors: Russell Lynn Whitson, Kingsport, TN (US); Samuel Leroy Gott, Kingsport, TN (US)

Correspondence Address: Tammye L. Taylor;Eastman Chemical Company, P.O. Box 511, Kingsport, TN, 37662-5075, US

(21) Appl. No.: 11/416,533

(22) Filed: May 3, 2006

(51) Int. Cl. C09B 67/00

(52) U.S. Cl. 524/502; 524/567

(57) ABSTRACT

Rigid polyvinyl chloride compositions are disclosed that are suitable for use in applications such as window profiles, door frames, siding, fences, gutters, pipes, electrical junction boxes, automobile interiors and exteriors, appliances, office equipment or medical devices. The disclosed compositions include polyvinyl chloride polymers or copolymers having incorporated therein 2,2,4-trimethyl-1,3-pentanediol diisobutyrate in amounts so as to improve the impact properties of the compositions. Processes for making such compositions are also disclosed.

### FIELD OF THE INVENTION

The invention relates to rigid polyvinyl chloride polymer compositions having improved impact properties, making them suitable for use in a variety of end-use applications. The compositions contain 2,2,4-trimethyl-1,3-pentanediol diisobutyrate used as an impact modifier in amounts sufficient to improve the impact properties of the compositions.

### BACKGROUND OF THE INVENTION

Polyvinyl chloride polymer and copolymer compositions, hereinafter “PVC,” are useful for a variety of applications, including medical, electrical, automotive, and building and construction. For example, PVC is used in the following products: appliances, furniture, window frames, drainage pipes, medical devices, power, data, and telecom wiring and cables, cable and wire insulation, resilient flooring, roofing membranes, automotive interiors and seat coverings, automotive exterior trim and parts, fashion and footwear, bottles and packaging, credit cards, and synthetic leather and other coated fabrics.

Rigid PVC, in particular, finds use in a variety of products, such as siding, gutters, windows, pipes and conduits, fittings, and the interior and exterior trim of automobiles.

While rigid PVC has many useful properties, it is often necessary or desirable to reduce the rigidity or brittleness to some extent, so as to prevent cracking or to provide needed flexibility. A useful impact modifier should be compatible with the PVC and improve the impact resistance, making it less prone to failure on impact, while maintaining the mechanical properties of the PVC, such as tensile strength. Other characteristics that impact modifiers may impart to rigid PVC are improved processing, improved rate of fusion, and low temperature flexibility.

Traditionally, PVC impact modifiers include polyacrylic resins, butadiene-containing polymers such as methacrylate butadiene styrene (MBS), and chlorinated polyethylene (CPE) resins. These polymers have been used as impact modifiers for rigid PVC, due to the intrinsic elastomeric properties of the impact modifiers themselves. While these materials are suitable for such uses, traditional impact modifiers are expensive when compared with the cost of the rigid PVC. It clearly would be an advance in the art to provide rigid PVC formulations having improved impact properties, but without the need for relatively expensive elastomeric polymers as impact modifiers.

Conventional plasticizers have not typically been used in applications that require rigidity because when used in conventional plasticizer amounts, the tensile strength of the PVC is adversely affected. Thus, 2,2,4-trimethyl-1,3-pentanediol diisobutyrate, hereinafter “(TXIB)”, is typically used in relatively large amounts as a plasticizer in PVC compositions in many diverse applications ranging from flooring and wall coverings to sporting goods and toys.

For example, U.S. Pat. No. 3,674,611 discloses decorative surface coverings that include a foamable resinous polymer composition applied to a base. The resins, which can be homopolymers or copolymers of vinyl chloride, are dispersed as a plastisol in a plasticizer at concentrations in which the plasticizer is present in amounts from about 35-150 parts, or from about 50-80 parts, per 100 parts resin. Suitable diesters are said to include diesters of aromatic or aliphatic acids, including 2,2,4-trimethyl-1,3-pentanediol diisobutyrate.

U.S. Pat. No. 3,737,930 discloses a cushion whose gel core comprises about 6-14 parts by weight, preferably about 9 parts by weight, of a plasticizer for each part by weight of high molecular weight polyvinyl chloride resin. Suitable plasticizers include 2,2,4-trimethyl-1,3-pentanediol diisobutyrate (TXIB), which preferably is used in combination with a less volatile diester such as dioctyl phthalate.

U.S. Pat. No. 4,232,076 discloses a method for penetrating colorants into polyvinyl chloride compositions such as gelled plastisol or sintered dry-blend polyvinyl chloride compositions containing about 25-150 parts of plasticizer per 100 parts of resin. The reference discloses a large group of plasticizers, including 2,2,4-trimethyl-1,3-pentanediol diisobutyrate. The total weight of plasticizers, both primary and secondary, in the polyvinyl chloride plastisol compositions amounts to about 20-60 wt. %, preferably about 30-50 wt. %, of the composition. The formulation of Example XVII contains a total of 910 grams of dispersion and extender grades of polyvinyl chloride and a total of 409 grams of five primary and secondary plasticizers, of which 80 grams is 2,2,4-trimethyl-1,3-pentanediol diisobutyrate.

U.S. Pat. No. 5,248,546 discloses a multilayer composition comprising a first layer (A) and at least one other layer (B), each comprising a polyvinyl chloride composition. The compositions are said to be chemically resistant to chlorofluorocarbon compounds. At least one optional plasticizer may be included in any layer, in an amount of about 1-20 parts, or about 1-10 parts, per hundred parts of resin. Suitable carboxylic ester plasticizers are said to include derivatives of isobutyric acid. The document further provides that at least one impact modifier is necessary in at least one layer, and that impact modifiers may be present in more than one layer. Suitable impact modifiers, which are said to generally contain a rubbery core component, include various PARALOID products from Rohm & Haas.

U.S. Pat. Appln. Publ. No. 2003/0100620 discloses polyvinyl chloride resin compositions that are prepared by the incorporation of various sulfur-containing additives in plastisols containing dry particulate PVC dispersion resins, the resulting compositions being used in the production of whitened PVC foams. The plastisol optionally includes a PVC blending resin [0054]. A “standard generic foam formula” is disclosed that includes 70 parts by weight PVC dispersion resin, 30 parts by weight PVC blending resin, 55 parts by weight dioctyl phthalate plasticizer, and 5 parts by weight 2,2,4-trimethyl-1,3-pentanediol diisobutyrate plasticizer.

U.S. Pat. Appln. Publ. No. 2003/0157150 discloses a formulation for manufacturing an antimicrobial article such as a glove that includes a stabilizer, a powdered antimicrobial agent, a surfactant, 80-120 parts by weight of a PVC resin, and 35-125 parts by weight of a plasticizer blend. The plasticizer blend preferably comprises 10-30 parts by weight of 2,2,4-trimethyl-1,3-pentanediol diisobutyrate and 20-95 parts by weight of another plasticizer selected from the group consisting of dioctyl phthalate, diisononyl phthalate, dioctyl terephthalate, butylbenzyl phthalate, and a combination thereof.

U.S. Pat. Appln. Publ. No. 2005/0003154 discloses a laminated plastic siding panel comprising a plastic sheet to which a coloring sheet is bonded. The plastic sheet may include an impact modifier as an additive, for example, an ACRYLOID product available from Rohm & Haas. The coloring sheet comprises a pigment and a binder that preferably comprises a vinyl resin, preferably PVC, at least one plasticizer, and at least one organic solvent. Preferred plasticizers are diesters of dicarboxylic acids with saturated alcohols, including diisodecyl phthalate, the 2-ethylhexyl ester of nonanedioic acid, and 2,2,4-trimethyl-1,3-pentanediol diisobutyrate.

The vinyl plastisol preferably comprises about 25-50 wt. %, more preferably about 42-48 wt. %, most preferably about 45 wt. % of PVC, and preferably about 16-24 wt. %, more preferably about 20-23 wt. %, most preferably about 21 wt. % of plasticizer. A particularly preferred plastisbl contains three plasticizers: about 9.9 wt. % of diisodecyl phthalate, about 5.9 wt. % of the 2-ethylhexyl ester of nonanedioic acid, and about 5.4 wt. % of 2,2,4-trimethyl-1,3-pentanediol diisobutyrate.

JP Appl. No. 2000048917 (Patent Abstracts of Japan 2000309742) discloses an additive for matte coating prepared by mixing 100 parts by weight of dry polyvinyl chloride powder with 60 parts by weight of 2,2,4-trimethyl-1,3-pentanediol diisobutyrate, kneading the mixture using a dissolver type mixer at 25° C. and 800 rpm for 3 minutes, and incorporating the resulting particles into a composition for a matte coating.

There remains a need in the art for rigid polyvinyl chloride compositions which exhibit acceptable impact properties, without the need for expensive impact modifiers.

### SUMMARY OF THE INVENTION

The invention pertains to polyvinyl chloride (PVC) compositions having incorporated therein 2,2,4-trimethyl-1,3-pentanediol diisobutyrate in amounts sufficient to improve the impact properties of the PVC compositions, for example, in amounts less than about 10 phr.

The present invention relates to rigid polyvinyl chloride compositions exhibiting improved impact properties, comprising: a polyvinyl chloride resin; and 2,2,4-trimethyl-1,3-pentanediol diisobutyrate (TXIB) in amounts up to about 10 phr, wherein the TXIB is dispersed in the polyvinyl chloride resin.

The invention relates also to processes for the manufacture of rigid polyvinyl chloride compositions in which 2,2,4-trimethyl-1,3-pentanediol diisobutyrate is incorporated in amounts up to about 10 phr to improve the impact properties of the compositions.

### DETAILED DESCRIPTION OF THE INVENTION

The present invention may be understood more readily by reference to the following detailed description of the invention and to the examples provided. It is to be understood that this invention is not limited to the specific processes and conditions described, because specific processes and process conditions for processing rigid PVC compositions may vary. It is also to be understood that the terminology used is for the purpose of describing particular embodiments only and is not intended to be limiting.

As used in the specification and the claims, the singular forms “a,” “an,” and “the” include plural referents unless the context clearly dictates otherwise.

By “comprising” or “containing” we mean that at least the named compound, element, particle, etc. must be present in the composition or article, but does not exclude the presence of other compounds, materials, particles, etc., even if the other such compounds, material, particles, etc. have the same function as what is named.

According to the invention, polyvinyl chloride (PVC) compositions are provided containing 2,2,4-trimethyl-1,3-pentanediol diisobutyrate used as an impact modifier in amounts sufficient to improve the impact properties of the PVC compositions. The amounts of 2,2,4-trimethyl-1,3-pentanediol diisobutyrate sufficient to improve impact properties vary from amounts up to about 10 phr, or up to about 8 phr, or up to about 5 phr. For example, 2,2,4-trimethyl-1,3-pentanediol diisobutyrate is provided in amounts from about 0.8 phr to about 9 phr or from about 1 phr to 5 phr or from about 2 phr to 4 phr or in amounts further described elsewhere herein.

While diesters such as 2,2,4-trimethyl-1,3-pentanediol diisobutyrate are known for use as plasticizers for PVC compositions, when used for that purpose, they are typically included in such compositions at high concentrations, for example in amounts greater than 20 phr up to 100 phr or even greater. When used as a plasticizer the impact resistance of the PVC cannot be modified without adversely affecting the tensile strength of the PVC. However, when used in the amount provided in the present invention, the PVC compositions exhibit improved impact properties, while maintaining other desirable mechanical properties such as tensile strength.

The amount of 2,2,4-trimethyl-1,3-pentanediol diisobutyrate present in the PVC compositions according to the invention may be any amount less than about 10 phr. For example, a suitable amount of 2,2,4-trimethyl-1,3-pentanediol diisobutyrate may vary within a wide range from about 0.8 phr to about 9 phr or from about 1 phr to about 5 phr based on the weight of the polymer in the PVC compositions, or as already described. We have discovered that, when used in these amounts or in amounts less than those typically used when serving as a plasticizer, 2,2,4-trimethyl-1,3-pentanediol diisobutyrate may be used as an impact modifier when added to rigid PVC formulations to improve the impact properties of the compositions, without adversely affecting the tensile strength of such compositions. The resulting rigid PVC formulations exhibit impact properties comparable with compositions containing conventional elastomeric impact modifiers, but at a much cheaper cost.

This invention thus relates to the use of 2,2,4-trimethyl-1,3-pentanediol diisobutyrate as an impact modifier for rigid PVC compositions, to thus obtain improved impact properties, and to methods of making and using such compositions.

We note that 2,2,4-trimethyl-1,3-pentanediol diisobutyrate (CAS # 6846-50-0) can be produced by known techniques, including those described in U.S. Pat. No. 4,110,539, incorporated herein by reference. The molecule finds use as a plasticizer in various polymer compositions, including PVC compositions, and is available as TXIB Formulation Additive from Eastman Chemical Company, Kingsport, Tenn.

Polyvinyl chloride polymers useful according to the invention include those described in the “Vinyl Chloride Polymers” entry of Kirk-Othmer Encyclopedia of Chemical Technology, Vol. 24, 4th ed., (1997) pp. 1017-1053, which is incorporated herein by reference.

For example, PVC polymers useful according to the invention include homopolymers of vinyl chloride and those vinyl chloride polymer resins having at least 70 wt. % repeating units polymerized from a vinyl chloride monomer, or at least 80 wt. %, or at least 90 wt. %, or even 95 wt. % or more of repeating units polymerized from a vinyl chloride monomer.

The polyvinyl chloride compositions of the invention may comprise repeating units polymerized from a vinyl chloride monomer, and may also include comonomers up to 30 weight percent of the copolymer from, without limitation, one or more of: the esters of acrylic acid, for example, methyl acrylate, ethyl acrylate, butyl acrylate, octyl acrylate, cyanoethyl acrylate, and the like; vinyl esters such as vinyl acetate and vinyl propionate; esters of methacrylic acid, such as methyl methacrylate, ethyl methacrylate, hydroxyethyl acrylate, butyl methacrylate, and the like; nitriles, such as acrylonitrile and methacrylonitrile; acrylamides, such as methyl acrylamide, N-methylol acrylamide, N-butoxy methacrylamide, and the like; halogen containing vinyl monomers such as vinylidene chloride vinylidene fluoride, and vinyl bromide; vinyl ethers such as ethylvinyl ether, chloroethyl vinyl ether and the like; the vinyl ketones, styrene derivatives including .alpha.-methyl styrene, vinyl toluene, chlorostyrene; vinyl naphthalene; olefins such as ethylene, butene, isobutylene, propylene and hexene; and other copolymerizable monomers or mixtures of monomers having suitable reactivity ratios with vinyl chloride and known to those skilled in the art.

Some embodiments of the present invention may employ PVC blends with crosslinked PVC or crosslinked PVC alone. Crosslinked PVC polymers can be made by polymerizing vinyl chloride in the presence of cross-linking monomers such as the aforementioned diallyl phthalate, trimethylol propane triacrylate, allyl methacrylate, and the like, as taught in U.S. Pat. Nos. 4,755,699 and 5,248,546, the relevant portions of which are incorporated herein by reference.

The described homopolymers and copolymers are commercially available and may be produced by any suitable polymerization method including suspension, dispersion or blending. For example, polyvinyl chloride polymers prepared using suspension processes are suitable for use in the present invention.

When we say that the PVC compositions according to the invention are rigid we mean, for example, that the compositions are unmodified or unplasticized PVC that contains small amounts or no plasticizer. Whereas, flexible or plasticized PVC, typically may include plasticizers at levels greater than 12 phr. Thus, rigid PVC according to the present invention is characterized by a having a higher level of tensile strength than modified PVC compositions that are classified as flexible.

Also, according to the present invention rigid PVC refers to the property of a given compound having more than a certain tensile modulus. For example, PVC may be characterized as rigid when it has a tensile modulus that exceeds 10⁵ psi (or 689 MPa), and semirigid when its tensile modulus falls between 3×10³ and 10⁵ psi (20.7 MPa), and flexible when it has a tensile modulus that is less than 3×10³ psi (or 20.7 MPa) (the tensile modulus values are based on standard ASTM conditions of 23° C. and 50% relative humidity). Therefore, rigid PVC according to the present invention may have tensile modulus values that vary over a wide range, for example, the tensile modulus values may be from about 800 MPa to about 1000 MPa, or from about 1000 MPa up to about 2000 MPa or even up to 3000 MPa or greater.

The method by which the 2,2,4-trimethyl-1,3-pentanediol diisobutyrate may be incorporated into the PVC compositions is not particularly limited. Any conventional method known to those of skill in the art for incorporating impact modifiers into PVC formulations may be used. For example, the 2,2,4-trimethyl-1,3-pentanediol diisobutyrate and the PVC in dry form may be mixed in any suitable manner such as on a two roll mill or in an extruder with a mixing head. By further example, these compositions may be prepared using the methods discussed herein.

The effect of 2,2,4-trimethyl-1,3-pentanediol diisobutyrate on the impact properties of rigid PVC compositions may be determined by tensile strength, tensile modulus or impact resistance using conventional test methods.

In another aspect of the present invention, additional impact modifiers may be optionally added to the compositions of the present invention to enhance the performance properties of the PVC polymers. Suitable impact modifiers include traditional, elastomeric impact modifiers such as polymers prepared substantially from methacrylate, styrene, and butadiene (e.g., “MBS”) resins, MBS further comprising acrylonitrile monomers (e.g., “MABS”), polyacrylic resins and acrylic impact modifiers (e.g., AIM) based on an acrylic rubber (e.g., polyalkyl acrylate) and an acrylic outer stage (e.g., polymethyl methacrylate), chlorinated polyethylene (“CPE”), and polymers having a siloxane rubber. Various MBS and AIM impact modifiers are available from the Rohm and Haas Company, Philadelphia, Pa.

For example, acrylic impact modifiers (AIM), methacrylate butadiene styrene (MBS), or chlorinated polyethylene (CPE) may be added to the 2,2,4-trimethyl-1,3-pentanediol diisobutyrate to provide further improvements in impact properties while providing a cost saving by lowering the amount of the more expensive elastomeric impact modifiers required. In these formulations, the 2,2,4-trimethyl-1,3-pentanediol diisobutyrate may added in amounts up to about 8 phr and the elastomeric impact modifiers may be added in amounts of up to about 8 phr with the total amount of impact modifier added to the composition being less than about 10 phr. For example, the 2,2,4-trimethyl-1,3-pentanediol diisobutyrate could be added at about 5 phr to about 8 phr with the traditional elastomeric impact modifier added at about 2 phr to about 5 phr depending on the composition.

The rigid PVC compositions of the present invention are suitable for use in a variety of applications including, for example, window profiles, door frames, siding, fences, gutters, pipes, electrical junction boxes, automobile interiors and exteriors, appliances, office equipment, or medical devices.

This invention can be further illustrated by the following examples of preferred embodiments, although it will be understood that these examples are included merely for purposes of illustration and are not intended to limit the scope of the invention unless otherwise specifically indicated.

### EXAMPLES

Eastman TXIB was added to the rigid PVC formulations at levels of 0.2, 0.6, 0.8, 1.0, 2.0, 5.0 and 8.0 phr (parts per hundred resin). The control samples used for this evaluation include a sample containing no impact modifier (C1) and a sample containing 5 phr of Rohm & Haas, Paraloid KM-334 acrylic impact modifier (C2). The formulations were prepared by adding all of the ingredients listed in Table I, excluding the acrylic impact modifier or TXIB, to a Thyssen Henschel, Model FM 10 US mixer, at room temperature. The formulation also can be scaled up to 200 grams depending on the desired amount of final product.

TABLE 1
HIGH-PRESSURE PVC PIPE FORMULATIONS

| Ingredients | PHR (parts per hundred resin) |
|---|---|
| Geon 103 Resin | 100 |
| Advastab TM-387 Stabilizer | 0.3 |
| KM-334 Acrylic Impact Modifier | 0, 5.0 |
| TXIB Formulation Additive | 0.2, 0.6. 0.8, 1.0, 2.0, 5.0, 8.0 |
| Omyalite 90T Calcium Carbonate | 2.5 |
| Titanium Dioxide | 2.0 |
| Calcium Stearate | 0.8 |
| 165° F. AMP Paraffin Wax | 1.0 |
| Epolene E-20P Polymer | 0.15 |

Once the mixer was started, the dry blend was allowed to heat up to a temperature of about 150° F. When the acrylic impact modifier or TXIB was added, it was added slowly through the hole in the top of the mixer while continuing to mix at 150° F. The temperature was then allowed to continue to rise up to about 190° F., and the dry blend was then dispensed from the Henschel mixer into a paper bag. The dry blend was then poured onto a large paper and allowed to cool to room temperature. The dry blends are then fused by placing approximately 200 grams of the dry blend onto a Farrel Technolab two-roll mill, at 320-340° F. and mixing until the mixture sticks to the two-roll mill. After the mixture sticks to the two-roll mill, the mixing was continued for about 4 minutes. The hot vinyl was carefully removed and place into a Multipress, model # 100 ton, 4 post press with a 10″ diameter piston. The press was set at approximately 350° F. The vinyl sample was placed between to chrome plated plates, 12″×12″ with a 70-75 mil shim between the plates. The sample was then pressed for 12 minutes and then cooled and removed from the press. Finished 12×12 sheets at a thickness of 75 mils are removed and submitted to the TS&D Physical Testing Laboratories for physical properties and impact resistance. Tensile Strength and Modulus are determined by ASTM method D638. Impact resistance is determined by ASTM method D3763.

Tensile strength testing of the rigid PVC formulations using TXIB, at 0.2 phr, 0.6 phr, 0.8 phr, 1.0 phr, 2.0 phr, 5.0 phr and 8.0 phr, demonstrates that the tensile strength is not adversely affected when using the TXIB as an impact modifier at the levels required in the present invention. As shown in Table 2 the tensile strengths of the TXIB formulations are the same as those of the C1-control sample with no impact modifier added and the C2-control sample with a traditional acrylic impact modifier added at 5 phr. Additionally, Table 2 illustrates that the tensile modulus remains in the range of rigid PVC (greater than 689 MPa) when using the TXIB at the levels required in the present invention.

TABLE 2
PHYSICAL PROPERTIES

| | | | | Tensile |
|---|---|---|---|---|
| | Level TXIB | Tensile Strength | Elongation | Modulus |
| Sample | (phr) | Break, (MPa) | Break, (%) | (MPa) |
| C1 | 0 | 40.1 | 2.8 | |
| C1a | 0 | 40.1 | 5.3 | |
| C2 | 0 | 42.3 | 38.2 | |
| C2a | 0 | 40.0 | 14.3 | |
| 1 | 0.2 | 48.2 | 3.5 | |
| 1a | 0.2 | 46.0 | 2.5 | 3053 |
| 2 | 0.6 | 45.7 | 3.2 | 3094 |
| 3 | 0.8 | 45.3 | 3.9 | 3050 |
| 4 | 1.0 | 46.6 | 3.3 | |
| 4a | 1.0 | 40.9 | 4.0 | 3090 |
| 5 | 2.0 | 45.3 | 2.5 | |
| 5a | 2.0 | 41.5 | 6.2 | 3048 |
| 6 | 5.0 | 38.3 | 10.6 | |
| 6a | 5.0 | 44.1 | 3.4 | 2895 |
| 7 | 8.0 | 44.6 | 2.2 | |
| 7a | 8.0 | 35.8 | 1.7 | 3134 |

ASTM D 638 - Tensile Strength
C1, C1a - Control 1 with no impact modifier present
C2, C2a - Control 2 containing only acrylic impact modifier at 5 phr (no TXIB present)

Table 3 illustrates that the impact resistance testing of the rigid PVC formulations using the TXIB provides an improvement in impact resistance that is equal to that seen with the traditional impact modifiers. Thus, the TXIB has been shown to improve the impact resistance of the rigid PVC formulations while maintaining the tensile strength.

TABLE 3
IMPACT RESISTANCE

| | Level TXIB | Maximum Load | Energy at Max | Total Energy |
|---|---|---|---|---|
| | (phr) | (kN) | Load (J) | (J) |
| C1 | 0 | 1.57 | 5.19 | 5.46 |
| C1a | 0 | 0.56 | 1.17 | 1.22 |
| C2 | 0 | 1.68 | 7.58 | 9.95 |
| C2a | 0 | 2.27 | 15.43 | 16.53 |
| 1 | 0.2 | 1.20 | 3.89 | 4.15 |
| 1a | 0.2 | 0.85 | 1.99 | 2.74 |
| 2 | 0.6 | 1.06 | 3.06 | 3.52 |
| 3 | 0.8 | 0.89 | 4.51 | 5.60 |
| 4 | 1.0 | 0.22 | 9.60 | 9.72 |
| 4a | 1.0 | 1.42 | 6.65 | 7.51 |
| 5 | 2.0 | 2.43 | 18.06 | 20.56 |
| 6 | 5.0 | 1.43 | 18.02 | 18.35 |
| 7 | 8.0 | 0.88 | 22.28 | 22.33 |

ASTM D 3763 - Instrumented Falling Weight Impact
C1, C1a - Control 1 with no impact modifier or plasticizer present
C2, C2a - Control 2 containing only acrylic impact modifier at 5 phr (no TXIB present)

Table 4 provides a summary of the chemical extraction properties of the TXIB when used as an impact modifier in rigid PVC formulations. Generally, when conventional rigid PVC compositions that contain high levels of TXIB are exposed to various media the TXIB may be extracted from the compositions causing the PVC to become more brittle and possibly to begin to crack over time. In the following series of tests PVC formulations were exposure to various media for 24 hours and the formulations were evaluated to determine if any weight loss occurred due to extraction of the TXIB. As shown in table 4, very little extraction of the TXIB occurs in the compositions of the present invention due to the low levels of TXIB used in these formulations.

TABLE 4
CHEMICAL EXTRACTION

| | Sample | | | | |
|---|---|---|---|---|---|
| | C1 | C2 | 5 | 6 | 7 |
| Level of TXIB (PHR) | | | 2 | 5 | 8 |
| Soapy Water¹, % Loss | −0.07 | −0.08 | −0.03 | −0.03 | −0.07 |
| CS OIl Extraction², % Loss | 0.00 | 0.01 | 0.00 | 0.00 | 0.01 |
| Hexane Extraction³, % Loss | 0.00 | 0.00 | 0.00 | 0.02 | 0.01 |
| Activated Carbon⁴, % Loss | 0.02 | 0.02 | 0.20 | 0.03 | 0.02 |

¹Extraction using 1% soapy water solution is run at 50° C. for 24 hrs.
²Cotton Seed Oil Extraction is run at 23° C. for 24 hrs.
³Hexane Extraction is run at 23° C. for 24 hrs.
⁴Weight Loss by activated carbon is run at 90° C. for 24 hrs.

We claim:

1. A polyvinyl chloride composition comprising:
a polyvinyl chloride resin, and
2,2,4-trimethyl-1,3-pentanediol diisobutyrate in an amount less than about 10 phr.

2. The polyvinyl chloride composition according to claim 1, wherein the 2,2,4-trimethyl-1,3-pentanediol diisobutyrate is present in an amount from about 0.8 phr to about 9 phr.

3. The polyvinyl chloride composition according to claim 1, wherein the 2,2,4-trimethyl-1,3-pentanediol diisobutyrate is present in an amount from about 1 phr to about 7 phr.

4. A polyvinyl chloride composition, comprising:
a polyvinyl chloride polymer resin in which polyvinyl chloride residues comprise at least 70 wt. % repeating units polymerized from a vinyl chloride monomer and up to 30 wt. % repeating units from other comonomers; and
2,2,4-trimethyl-1,3-pentanediol diisobutyrate dispersed in the polyvinyl chloride polymer resin in an amount from about 1 phr to about 8 phr, wherein the resulting composition has a tensile modulus greater than about 689 MPa.

5. A rigid polyvinyl chloride composition having improved impact properties comprising:
a polyvinyl chloride resin, and
2,2,4-trimethyl-1,3-pentanediol diisobutyrate in an amount up to about 10 phr, dispersed in the polyvinyl chloride resin.

6. The rigid polyvinyl chloride composition according to claim 5, wherein the 2,2,4-trimethyl-1,3-pentanediol diisobutyrate is present in an amount from about 1 phr to about 8 phr.

7. The rigid polyvinyl chloride composition according to claim 5, wherein the 2,2,4-trimethyl-1,3-pentanediol diisobutyrate is present in an amount from about 2 phr to about 5 phr.

8. The rigid polyvinyl chloride composition of claim 5, wherein the polyvinyl chloride resin has at least 70 wt. % repeating units polymerized from a vinyl chloride monomer and up to 30 wt % repeating units from other comonomers.

9. The rigid polyvinyl chloride composition of claim 5, wherein the polyvinyl chloride resin is in dry from and the composition is produced using a two roll mill or an extruder with a mixing head.

10. A process for producing the rigid polyvinyl chloride composition of claim 5, comprising:
mixing a dry blend of polyvinyl chloride resin at room temperature,
heating the resin up to a temperature of about 150° F.,
adding 2,2,4-trimethyl-1,3-pentanediol diisobutyrate in an amount up to about 10 phr slowly while continuing to mix at about 150° F.,
heating the resin and 2,2,4-trimethyl-1,3-pentanediol diisobutyrate mixture up to about 190° F.,
cooling the mixture to room temperature and then pouring the mixture onto a two-roll mill at about 320-340° F.,
mixing the mixture on the two-roll mill until the mixture sticks to the two-roll mill,
placing the resulting hot vinyl mixture into a multipress set a about 350° F., pressing the mixture for several minutes, and then removing the mixture from the press and allowing it to cool.

11. A rigid polyvinyl chloride composition exhibiting improved impact properties, comprising:
a polyvinyl chloride polymer resin,
2,2,4-trimethyl-1,3-pentanediol diisobutyrate in an amount from about 8 phr to about 2 phr, and
an elastomeric impact modifier in an amount from about 2 phr to about 8 phr,
wherein the 2,2,4-trimethyl-1,3-pentanediol diisobutyrate and the elastomeric impact modifier are dispersed in the polyvinyl chloride polymer and
wherein the amount of the 2,2,4-trimethyl-1,3-pentanediol diisobutyrate and the elastomeric impact modifier added to the composition is less than 10 phr in total.

12. The rigid polyvinyl chloride composition of claim 11 wherein the 2,2,4-trimethyl-1,3-pentanediol diisobutyrate is about 5 phr to about 8 phr and the elastomeric acrylic impact modifier is about 2 phr to about 5 phr.

13. The rigid polyvinyl chloride composition of claim 11 wherein the elastomeric impact modifier is one or more of acrylic impact modifer (AIM), methacrylate butadiene styrene (MBS), methacrylate acrylonitrile butadiene styrene (MABS), chlorinated polyethylene (CPE), or polymers having a siloxane rubber.

14. The rigid polyvinyl chloride composition of claim 5 or claim 11 wherein the composition is used in applications such as window profiles, door frames, siding, fences, gutters, pipes, electrical junction boxes, automobile interiors and exteriors, appliances, office equipment or medical devices.
